(19) United States
(12) Patent Application Publication
(10) Pub. No.: US 2016/0062696 A1
(43) Pub. Date: Mar. 3, 2016

(54) SOLID-STATE MEMORY DEVICE WITH PLURALITY OF MEMORY DEVICES

(71) Applicant: 2419265 ONTARIO LIMITED, Mississauga (CA)

(72) Inventors: Carmelo CERRELLI, Mississauga (CA); Steven Michael SPANO, Dryden, NY (US)

(21) Appl. No.: 14/934,817

(22) Filed: Nov. 6, 2015

Related U.S. Application Data
(63) Continuation-in-part of application No. 14/858,552, filed on Sep. 18, 2015.
Application No. 14/858,552 is a continuation-in-part of application No. 14/280,239, filed on May 16, 2014, now Pat. No. 9,177,654.
Application No. 14/280,239 is a continuation-in-part of application No. 14/226,239, filed on Mar. 26, 2014.

(51) Int. Cl. G06F 3/06

(52) U.S. Cl. CPC G06F 3/0638; G06F 3/0604; G06F 3/0688

(57) ABSTRACT

A solid-state memory device has memory devices and memory sticks. Each memory stick is coupled to a subset of the memory devices. A controller provides parallel access to the memory devices through the memory sticks to provide a virtualized memory device and to present to a host a single non-volatile storage unit with a total capacity based on capacities of the memory devices. The controller operates according to a memory mapping that map memory requests from the host to the memory devices. The memory devices, memory sticks, and the controller can be disposed within a rack unit housing that is shaped and sized to fit a data-center rack or cabinet. One or more wireless interfaces can connect the controller to a memory stick and connect a memory device to a memory stick for wireless communications of instructions and data within the solid-state memory device.

### FIELD

The present invention relates to electronic devices, more specifically, to electronic memory devices.

### BACKGROUND

The demand for computer memory steadily increases. Modern hard disk drives suffer from a number of problems. Moving parts, such as rotating platters, can render hard disk drives unreliable. Heat generation and noise is also a concern. Solid-state drives have been developed, but many of these lack the low-cost capacity to effectively replace hard disk drives. In addition, some known techniques of collating smaller storage devices suffer from inefficiencies or are prone to data loss events.

### SUMMARY

According to one aspect of the present invention, solid-state memory device includes a rack unit housing shaped and sized to fit a data-center rack or cabinet, a plurality of memory devices disposed within the rack unit housing, and a plurality of memory sticks disposed within the rack unit housing. Each memory stick of the plurality of memory sticks is coupled to a subset of memory devices of the plurality of memory devices. The solid-state memory device further includes a controller configured for parallel access to the plurality of memory devices through the plurality of memory sticks to access the plurality of memory devices as a virtualized memory device and to present to a host a single non-volatile storage unit with a total capacity based on capacities of the plurality of memory devices. The controller is further configured to operate according to a memory mapping to map memory requests from the host to the plurality of memory devices. The memory mapping defines a memory sector for access to each memory stick of the plurality of memory sticks. The memory sector maps to a plurality of host sectors defined by the host. Each host sector of the plurality of host sectors is mapped to a different memory device of each memory stick. Each memory sector of a plurality of memory sectors being mapped to a different memory stick for writing and reading the plurality of memory sectors in parallel to increase speed of memory accesses.

The controller can include a wireless interface and at least one memory stick of the plurality of memory sticks can include a wireless interface. The wireless interface of the controller and the wireless interface of the at least one memory stick can be configured to wirelessly communicate instructions and data between the controller and the at least one memory stick.

At least one memory stick of the plurality of memory sticks can include a wireless interface and at least one memory device of the plurality of memory devices can include a wireless interface. The wireless interface of the at least one memory stick and the wireless interface of the at least one memory device can be configured to wirelessly communicate instructions and data between the at least one memory stick and the at least one memory device.

The solid-state memory device can further include a power supply disposed within the rack unit housing for providing power to the solid-state memory device.

Each memory device of the plurality of memory devices can include a solid-state drive.

Each memory stick of the plurality of memory sticks can be a memory card stick and each memory device of the plurality of memory devices can include a memory card.

Each memory device of the subset of memory devices can be hot-swappable from each memory stick.

The solid-state memory device can further include a slidable tray supporting the plurality of memory devices and the plurality of memory sticks within the rack unit housing. The slidable tray is configured to slide into the rack unit housing and out of the rack unit housing for inspection and hot swapping of at least one of the plurality of memory devices and the plurality of memory sticks.

A data-center rack or cabinet can include a plurality of the solid-state memory devices described above.

According to another aspect of the present invention a solid-state memory device includes a plurality of memory devices and a plurality of memory sticks. Each memory stick of the plurality of memory sticks is coupled to a subset of memory devices of the plurality of memory devices. The solid-state memory device further includes a controller configured for parallel access to the plurality of memory devices through the plurality of memory sticks to access the plurality of memory devices as a virtualized memory device and to present to a host a single non-volatile storage unit with a total capacity based on capacities of the plurality of memory devices. The controller includes a wireless interface and at least one memory stick of the plurality of memory sticks includes a wireless interface. The wireless interface of the controller and the wireless interface of the at least one memory stick are configured to wirelessly communicate instructions and data between the controller and the at least one memory stick. At least one memory device of the plurality of memory devices includes a wireless interface. The wireless interface of the at least one memory stick and the wireless interface of the at least one memory device are configured to wirelessly communicate instructions and data between the at least one memory stick and the at least one memory device.

The controller can be further configured to operate according to a memory mapping to map memory requests from the host to the plurality of memory devices. The memory mapping can define a memory sector for access to each memory stick of the plurality of memory sticks. The memory sector can map to a plurality of host sectors defined by the host. Each host sector of the plurality of host sectors can be mapped to a different memory device associated with each memory stick. Each memory sector of a plurality of memory sectors can be mapped to a different memory stick for writing and reading the plurality of memory sectors in parallel to increase speed of memory accesses.

Each of the memory sticks of the plurality of memory sticks can include a wireless interface, such that all memory sticks are configured to wirelessly communicate instructions and data with the controller.

Each of the memory devices of the plurality of memory devices includes a wireless interface, such that all memory devices are configured to wirelessly communicate instructions and data with the plurality of memory sticks.

Each memory device of the plurality of memory devices can include a solid-state drive.

Each memory stick of the plurality of memory sticks can be a memory card stick and each memory device of the plurality of memory devices can include a memory card.

Each memory device of the subset of memory devices can be hot-swappable from each memory stick.

The solid-state memory device can further include a rack unit housing shaped and sized to fit a data-center rack or cabinet. The plurality of memory devices, the plurality of memory sticks, and the controller can be disposed within the rack unit housing.

The solid-state memory device can further include a slidable tray supporting the plurality of memory devices and the plurality of memory sticks within the rack unit housing. The slidable tray is configured to slide into the rack unit housing and out of the rack unit housing for inspection and hot swapping of at least one of the plurality of memory devices and the plurality of memory sticks.

### BRIEF DESCRIPTION OF THE DRAWINGS

The drawings illustrate, by way of example only, embodiments of the present invention.

FIG. 1 is a perspective diagram of a solid-state memory device according to some embodiments.

FIG. 2 is a perspective diagram of a solid-state memory device according to other embodiments.

FIG. 3 is a block diagram of a solid-state memory device.

FIG. 4 is a block diagram of components of an instruction memory.

FIG. 5 is a block diagram of a file routing table and file systems.

FIGS. 6a-6b are schematic diagrams of a solid-state memory device according to other embodiments.

FIG. 7 is a perspective diagram of a solid-state memory device according to further embodiments.

FIG. 8 is a block diagram of a solid-state memory device, such as that shown in FIG. 7.

FIG. 9 is a diagram of a memory card stick having a plurality of memory cards.

FIG. 10 is a diagram of a memory mapping.

FIG. 11 is a perspective diagram of a rack unit according to an embodiment.

FIG. 12 is a perspective diagram of a data-center rack according to an embodiment.

FIG. 13 is a perspective diagram of another data-center rack according to another embodiment.

FIG. 14 is a block diagram of a solid-state memory device according to another embodiment.

FIG. 15 is a perspective diagram of a rack unit according to another embodiment.

FIG. 16 is a side view of a sliding rail configuration according to an embodiment.

FIG. 17 is a perspective diagram of an assembly of rack units according to an embodiment.

### DETAILED DESCRIPTION

The present invention is directed to a solid-state memory device that allows a plurality of removable memory cards to emulate a universal serial bus (USB) mass storage device, serial ATA (SATA) hard disk drive, or similar device. This provides the ability to store large amounts of data within a bank of memory cards while retaining the convenience and functionality of known storage devices.

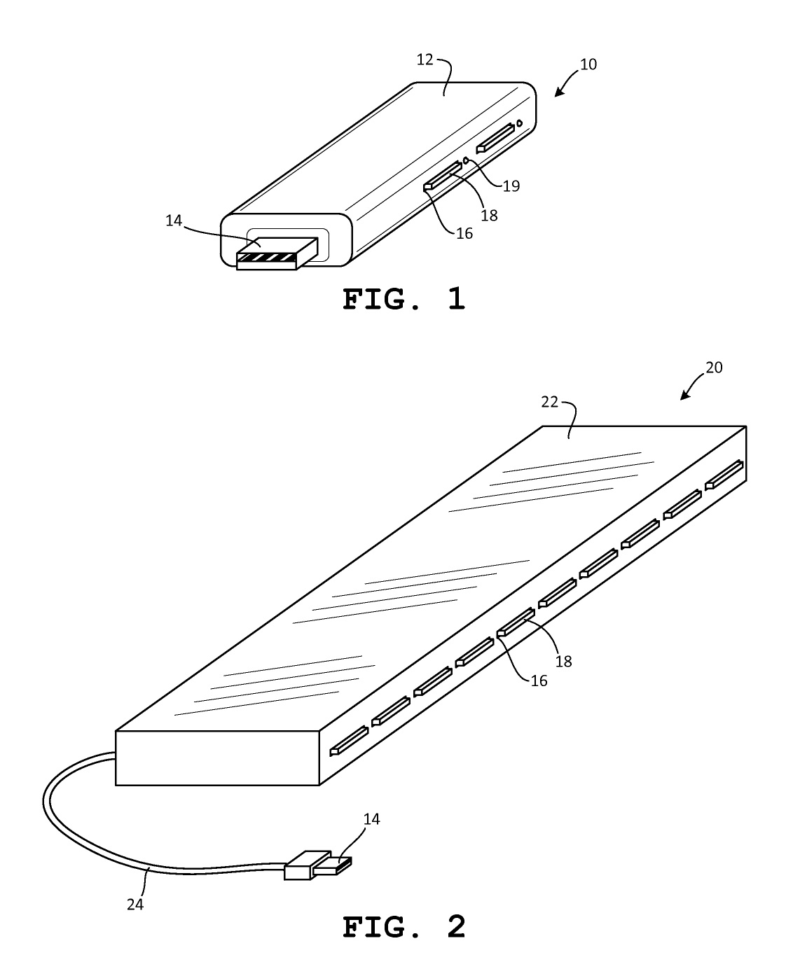

FIG. 1 shows a solid-state memory device 10. The memory device 10 includes a housing 12 having a connector 14, such as a USB Type A plug that protrudes directly from the housing 12 to give the memory device 10 a configuration similar to a portable USB memory stick. The housing 12 further includes openings 16 aligned with a plurality of memory card connectors located inside the housing 12 to allow insertion and removal of a plurality of removable memory cards 18. Indicators 19, such as red and green bi-color status light-emitting diodes (LEDs) can be provided to indicate read/write access and/or faults. Although two openings 16 are shown, any number of openings 16 can be provided to receive any number of removable memory cards 18. The solid-state memory device 10 is portable and can directly plug into any suitable USB host device, such as a computer.

FIG. 2 shows a solid-state memory device 20. Features and aspects of other embodiments described herein can be used with the presently described embodiments, and the description of like-identified components can be referenced. The memory device 20 includes a housing 22 and a connector 14, such as a USB Type A plug that is attached to a circuit board contained inside the housing by a USB cable 24. The housing 22 further includes openings 16 aligned with a plurality of memory card connectors situated inside the housing 22 to allow insertion and removal of a plurality of removable memory cards 18. Status indicators (not shown) may also be provided. Although ten openings 16 are shown, any number of openings 16 can be provided to receive any number of removable memory cards 18. The solid-state memory device 20 can be used as fixed or portable storage, with the cable 24 allowing it to plug into any suitable USB host device, such as a computer.

The removable memory cards 18 may be Secure Digital (SD) cards, miniSD cards, or microSD cards. The storage capacity of such cards can be any available size, such as 16 GB, 64 GB, 128 GB, 1 TB, etc., provided that number of cards and the file system selected supports such.

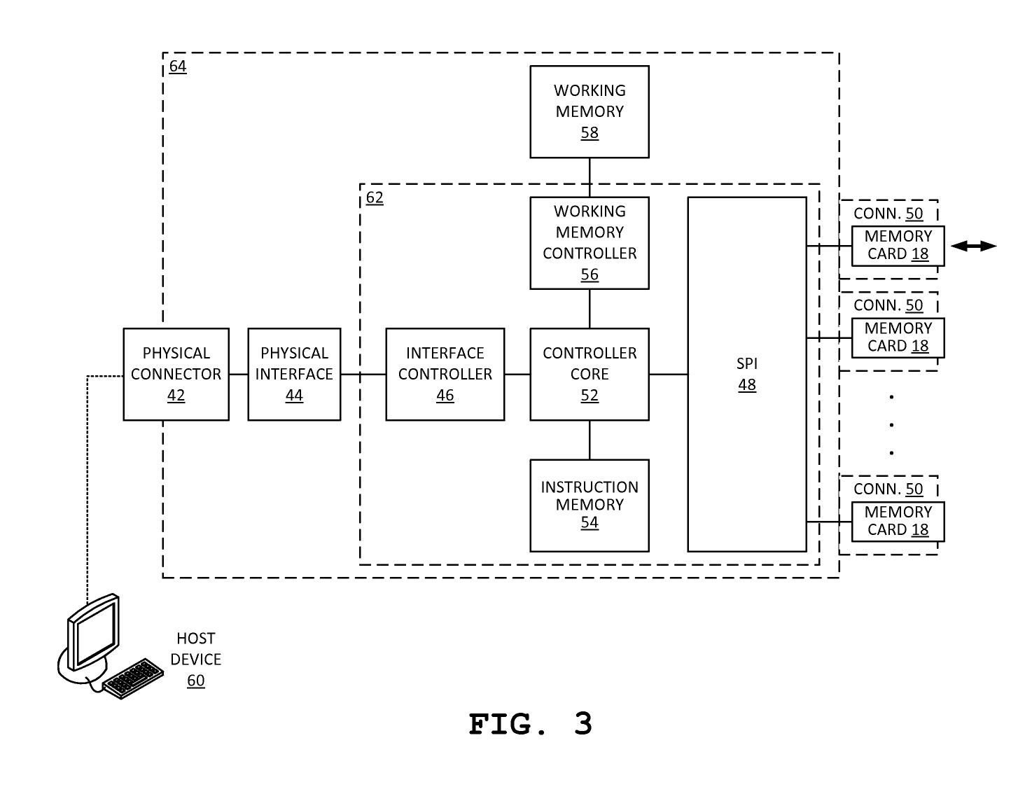

FIG. 3 shows a block diagram of a solid-state memory device, such as the solid-state memory devices 10, 20 of FIGS. 1 and 2 and the device partially shown in FIGS. 6a-6b. The components of the memory device shown in FIG. 3 are examples, and the functionality discussed below can be implemented in other kinds of components, fewer more generalized components, or a greater number of more specialized components.

The solid-state memory device includes a physical connector 42, a physical interface 44 connected to the physical connector 42, an interface controller 46 connected to the physical interface 44, and a serial peripheral interface (SPI) 48. A plurality of memory card connectors 50 are connected to the SPI 48. Each memory card connector 50 is configured to receive a removable memory card 18. The memory device further includes a controller core 52 connected between the interface controller 46 and the serial peripheral interface 48 to manage mass-storage type access to the aggregate capacity of the memory cards 18. The memory device can further include instruction memory 54 connected to the controller core 52, a working memory controller 56 connected to the controller core 52, and working memory 58 connected to the working memory controller 56.

In some embodiments, the physical connector 14 is a universal serial bus (USB) connector that includes a USB Type A plug that is connectable to a USB host device 60, such as a computer. Alternatively, the USB connector 14 can include another type of USB connector or a connector made in accordance with another standard.

In some embodiments, the physical interface 44 is a USB physical interface 44 that is configured to translate digital logic signals between USB controller 46, which operates on 8-bit packets, and the two USB D+ and D− signal lines at the USB connector 42. The USB physical interface 44 can include a high-speed USB transceiver chip, such as those available under the designation USB3319 from Microchip Technology of Chandler, Ariz.

In some embodiments, the interface controller 46 is a USB controller 46 that is configured to transfer data, read/write commands, and handshaking and flow-control communications between the USB physical interface 44 and the controller core 52. The USB controller 46 operates on 8-bit packets.

The USB connector 14, physical interface 44, and controller 46 can be implemented according to the USB 2.0 Specification, USB 3.0 Specification, or similar.

The SPI 48 provides communication between the controller core 52 and the plurality of memory cards 18. In one example, the SPI 48 is configured to translate 32-bit read and write operations from the controller core 52 into 1-bit or 4-bit command and data cycles for the memory cards 18. The SPI 48 can also be connected to indicators 19 (FIG. 1) and control the indicators 19 to illuminate depending on read/write access and/or fault conditions.

The connectors 50 provide physical connections to the removable memory cards 18. The connectors 50 may be off-the-shelf items that allow physical removal and replacement of the removable memory cards 18. However, in some embodiments, the removable memory cards 18 may be locked in place, by for example the shape of the housing or other means, so as to physically prevent removal of memory cards 18.

The controller core 52 is configured to present the removable memory cards 18 to the host 60 as a single non-volatile storage unit with a total capacity substantially equal to the sum of individual capacities of the removable memory cards 18. In some embodiments, the controller core 52 operates on inbound 8-bit packets received from the USB controller 46 and likewise provides outbound 8-bit packets to the USB controller 46 for transmission to the host 60. The controller core 52 is configured to decode and respond to packets received from the host 60, and to communicate data between the host 60 and the plurality of removable memory cards 18. As such, the controller core 52 can be configured to operate the plurality of removable memory cards 18 according to a USB mass storage class device protocol and can thus be implemented to be responsive to any USB status/command/request packets that may be issued by the host 60 when connected to a USB mass storage class device. In other embodiments, such as in a SATA implementation, the controller core 52 operates on packets or other data structures of different size.

The controller core 52 can further be configured to use the working memory 58 as a buffer for data being communicated between the host 60 and the plurality of removable memory cards 18. The controller core 52 can be implemented as a programmable state machine, fixed logic structures, or a combination of such. The controller core 52 can be configured to operate on 32-bit logic.

The instruction memory 54 stores USB enumeration information, a command mapping for commands issuable by the host 60 and to which the controller core 52 is to respond, and one or more file routing tables for the plurality of removable memory cards 18. The instruction memory 54 may further include scratch pad memory for use by the controller core 52. The command mapping may be configured with standard storage access commands that may be requested by the host 60.

The interface controller 46, controller core 52, instruction memory 54, and working memory controller 56, can be implemented in a field-programmable gate array (FPGA) 62, such as a Spartan6 from Xilinx Inc., or as program code executable on a microprocessor.

The working memory controller 56 allows the controller core 52 to access the working memory 58, which the controller core 52 uses as a buffer for data being communicated between the host 60 and the plurality of removable memory cards 18. In this example, the working memory 58 includes 16-bit DDR2 RAM, and the working memory controller 56 is configured to translate 32-bit read and write requests from the controller core 52 into 16-bit data, address, refresh, and control cycles for the working memory 58.

With the optional exception of the physical connector 42, in some embodiments, all of the components of the solid-state memory device can be provided in a multi-layer printed circuit board (PCB) 64 that is enclosed by a housing (e.g., housings 12, 22 of FIGS. 1-2). The physical connector 42 can also be provided on the same PCB 64, as shown in FIG. 1, when the solid-state memory device 10 has USB-key form factor. In other embodiments (FIGS. 2 and 6b), the physical connector 42 can be cable-connected to the PCB 64 to provide a desktop form factor.

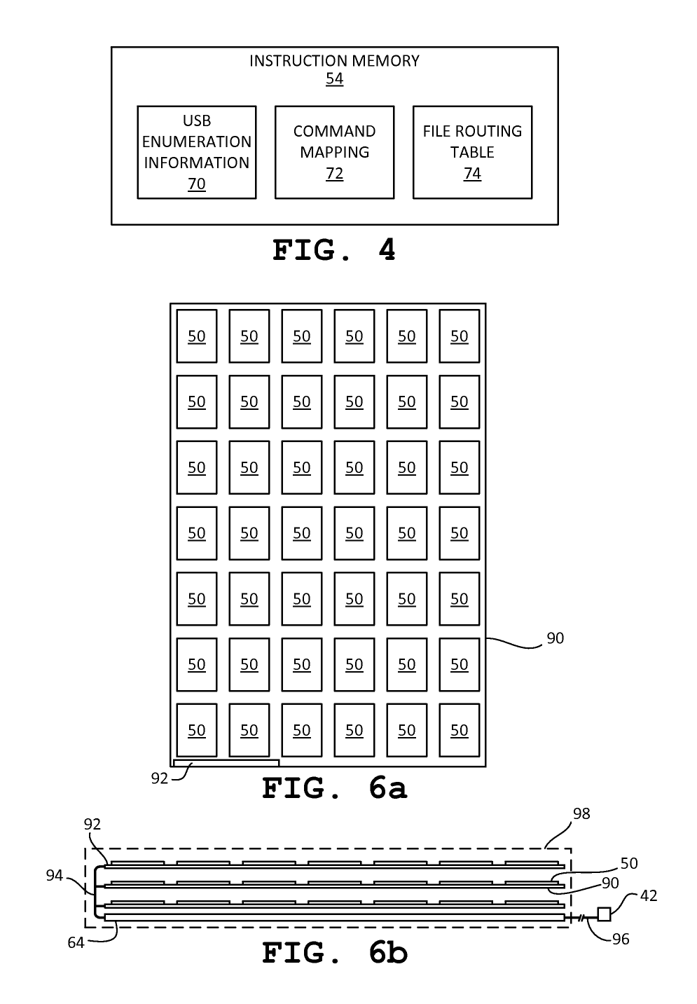

As shown in FIG. 4, in some embodiments, the instruction memory 54 stores USB enumeration information 70. The USB enumeration information 70 includes a device descriptor, configuration descriptor, interface descriptor, and any further information required for the host 60 to perform a USB enumeration sequence.

The instruction memory 54 can further store a command mapping 72. The command mapping maps commands, such as USB or ATA commands, which are expected to be issued by the host 60, to commands, such as ATA commands, that are compatible with the file system used on the memory cards 18.

The instruction memory 54 can further store a file routing table 74.

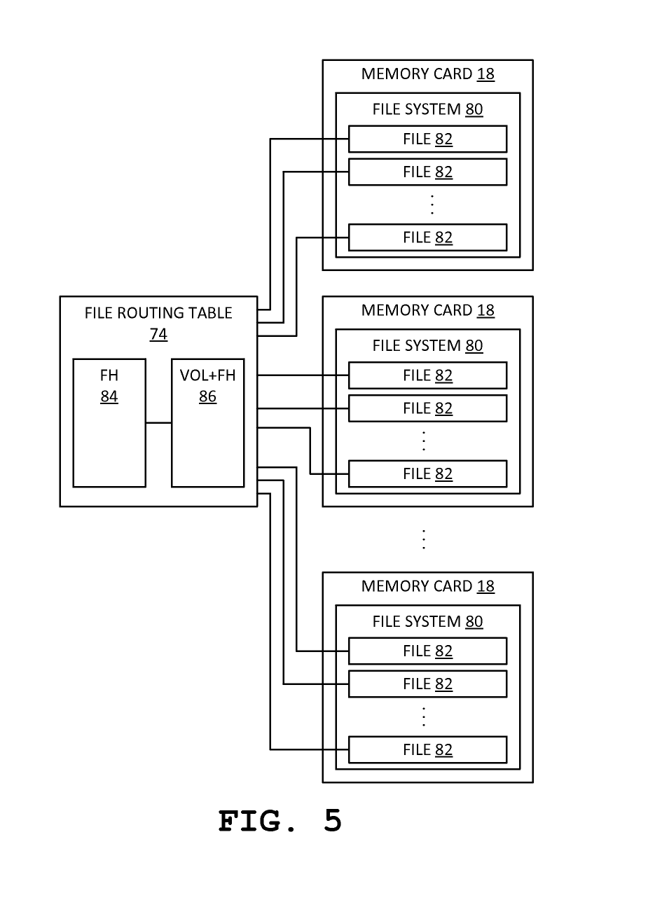

As shown in FIG. 5, each memory card 18 operates under its own dedicated file system 80. In some embodiments, the file system is FAT32. In other embodiments, other file systems can be used, such as NTFS, exFAT, and the like. In some embodiments, each memory card 18 has its own independent file system and can be accessed separately, if removed. The file handles for files 82 in a given memory card 18 are unique, but this is not necessarily so when two or more memory cards 18 are considered.

The file routing table 74 stores information about the memory cards 18 and allows the memory cards 18 to be presented to the host 60 as a single, large storage volume having a total capacity equal to the summed capacities of the memory cards 18. This can be achieved by, for example, the file routing table 74 storing a set of unique, host-facing file handles 84 that maps to a superset of unique volume and file handle pairs 86 of the sets of files handles in the file systems 80. The set of unique file handles 84 is itself configured to abide by a file system, such as FAT32 or similar, which is seen by the host 60 as a single large volume. Thus, the host 0 uses a file handle in the set 84 when accessing a particular file and such host-facing file handle is translated into a volume and file handle pair of the set 86 for access to the correct memory card 18 and the correct file thereon.

The file routing table 74 can be configured to appear as a directory table to the host 60. However, the file routing table 74 replaces structural elements of the directory table, such as starting cluster, file size, etc., with the unique volume and file handle pairs 86 that uniquely identify files in the memory cards 18.

A file handle can be a file name, a file name and extension, or other identifier native to the file system. Collisions between host-facing file handles 84, as may happen when two or more files 82 of different memory cards 18 have the same file name, can be avoided by adding numerical suffixes or similar to the host-facing file handles 84.

Further, in some embodiments, the logic of the file routing table 74 is constrained to completely store a given file in one of the memory cards 18. To achieve this, the file routing table 74, or another table associated therewith, can maintain values representative of the remaining storage capacities of the memory cards 18. Before a new file is written, the controller core 52 can check the file routing table 74 to identify memory cards 18 that each individually have enough space remaining to store the entire file. The controller core 52 then selects one of the memory cards 18 that individually has enough space to store the file. A file is not permitted to span multiple memory cards 18, which can help reduce the chance of data loss, as is found in some kinds of conventional drive spanning techniques, and further can allow for hot-swapping of the memory cards 18 as well as permit their removal for individual use.

When the file routing table 74 is not exactly formatted as a directory table compatible with the file system of the aggregate volume as seen by the host 60, the controller core 52 can be configured to generate a representation of the file routing table 74 that is compatible with such when the host 60 requests access. Such a representation can be generated in real time and can be cached for subsequent use. Hence, additional information, such as memory card free space, may be stored in the file routing table 74 and the controller core 52 can be configured to not provide such information to the host 60 in response to access commands. Alternatively, two or more file routing tables 74 are used, where one such table 74 mimics a directory table for the benefit of the host 60, and the remaining one or more of such tables store other information, such as free space, about the memory cards 18 and files thereon.

The controller core 52 can be configured to re-enumerate and scan the solid-state storage device when a memory card 18 is removed, added, or swapped, so as to validate, create, or delete relationships between the file handles of the sets 84, 86 in the file routing table. Scanning includes the controller core 52 obtaining directories of each of the file systems 80 and creating a unique, host-facing file handle of the set 84 for each file in such directories, if no such file handle exists. Scanning further includes removing file handles from the host-facing set 84 for the volume associated with a memory card 18 that has been removed. When a file on a newly inserted memory card 18 has a file handle that is the same as a file handle on an already present memory card 18, the controller core 52 can be configured to generate an host-facing file handle for one of such files by adding a suffix to a file name (e.g., “my file” and “my file (1)”). The actual file name for such a file is not changed.

In other embodiments, the controller core 52 is configured to operate the plurality of removable memory cards 18 as a redundant array of independent disks (RAID). RAID mirroring can be implemented to allow for data redundancy to help prevent data loss. Any RAID level (e.g., RAID 1, RAID 2, etc.) practical can be used. In some RAID implementations, the memory cards 18 are not swappable as that may corrupt the RAID data. In other embodiments, the controller core 52 is configured to provide data encryption to provide a highly secure and fault tolerant mass storage device.

FIGS. 6a-6b illustrate other embodiments, in which a solid-state memory device is configured to provide a multitude of memory cards within a standard 3.5-inch hard disk housing. Features and aspects of other embodiments described herein can be used with the presently described embodiments, and the description of like-identified components can be referenced. A plurality of memory card connectors 50 is disposed on a substrate 90, such as a PCB. The substrate 90 includes a connector portion 92 for receiving connection of a flex cable 94 to electrically connect the memory card connectors 50 to the flex cable 94. A plurality of memory cards 18 can be coupled to the memory card connectors 50.

Several assemblies of substrate 90, memory card connectors 50, and installed memory cards 18 can be stacked and connected to a PCB 64 having the physical interface 44, the interface controller 46, the serial peripheral interface 48, the controller core 52, the instruction memory 54, the working memory controller 56, and the working memory 58 discussed with respect to FIG. 3. Each substrate 90 is connected to the PCB 64 via one or more flex cables 94. In some embodiments, the solid-state memory device is configured to replace a hard disk drive having a rotating platter. Accordingly, the physical interface 44 is a SATA physical interface, USB 2.0 or USB 3.0 interface, or similar. Similarly, the interface controller 46 is a SATA controller, USB 2.0 or USB 3.0 controller, or similar, and the physical connector 42 is a SATA connector, USB connector, or similar coupled to the PCB via a ribbon cable 96.

The stacked substrates 90 bearing the memory cards 18 together with the controller PCB 64 can be arranged to fit inside the standard volume of a 3.5-inch hard disk. A housing (not shown) may also be provided with standard fastening points to a computer chassis.

The plurality of memory cards 18 may be of the removable kind (e.g., microSD), but need not be user-removable. That is, the arrangement of the substrates 90 and PCB 64 can be permanent or semi-permanent, requiring special tools to access and remove a memory card 18 or preventing any memory card removal altogether.

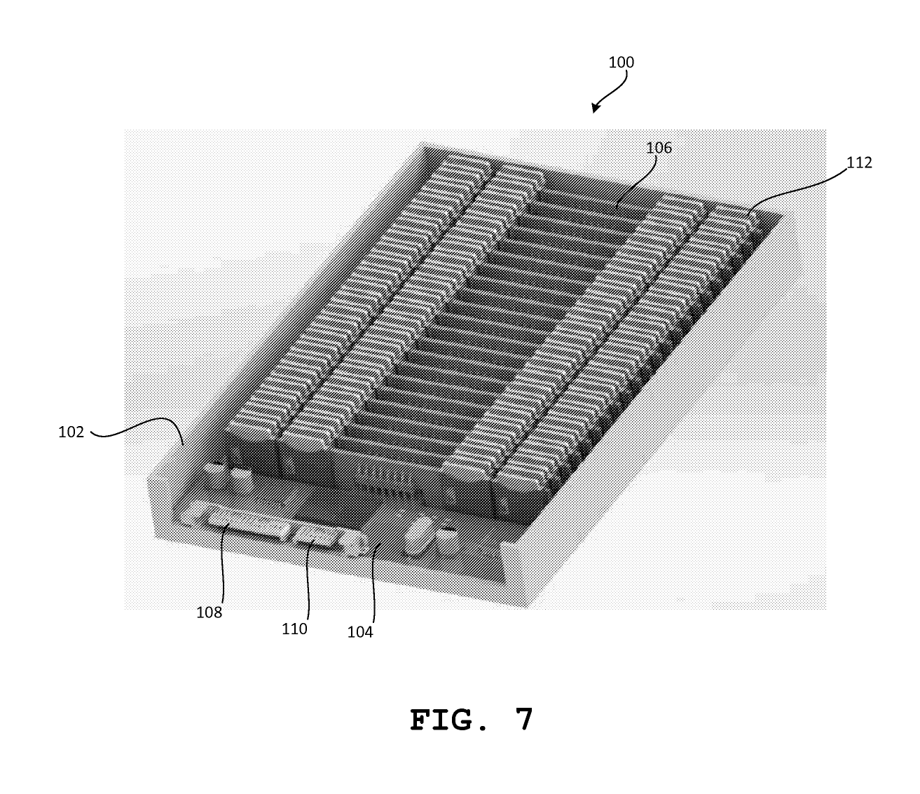

FIG. 7 shows a perspective view of another embodiment of the present invention. A solid-state memory device 100 includes a housing 102, a controller board 104, and a plurality of memory card sticks 106. The solid state memory device 100 is a hard drive replacement that, as far as a host device is concerned, operates as a conventional hard drive with rotating platters. Features and aspects of the other solid-state memory devices described herein can be used for the solid-state memory device 100.

The housing 102 is sized and shaped to conform to a 3.5-inch hard disk drive housing standard. The housing 102 can include mounting points and/or hardware for internal mounting to a computer case, mounting to a rack server, or the like. In other embodiments, the housing 102 can be sized and shaped differently.

The controller board 104 is a multi-layer PCB that contains interface hardware for connecting to a host device, such as a computer, and allowing the host device to have read and write access the plurality of memory card sticks 106. In this embodiment, the controller board 104 includes a SATA port 108 and a USB port 110 for connection to one or more respective ports at a host device. In other embodiments, one of the SATA port 108 and the USB port 110 is provided. In still other embodiments, a different type of port is provided.

Each of the plurality of memory card sticks 106 includes a plurality of memory cards 112. In some embodiments, such as that depicted, several memory cards 112 (e.g., four) are mounted on one face of the memory card stick 106, while several other memory cards 112 (e.g., four) are mounted on an opposite face of the memory card stick 106. This may increase memory card density in space-constrained implementations.

The number of memory card sticks 106 provided and the number(s) of memory cards 112 provided to each memory card stick 106 is not particularly limited.

The memory cards 112 may be removable SD cards, miniSD cards, microSD cards, or the like. The memory cards 112 may be installed in the memory card sticks 106 in a removable or a non-removable manner. That is, the memory cards 112 may be of a removable kind (e.g., microSD), but need not be user-removable, as discussed above. The memory card sticks 106 may be removable or non-removable from the controller board 104. Making the memory card sticks 106 and/or the memory cards 112 removable may advantageously allow a malfunctioning memory card stick 106 and/or memory card 112 to be swapped out.

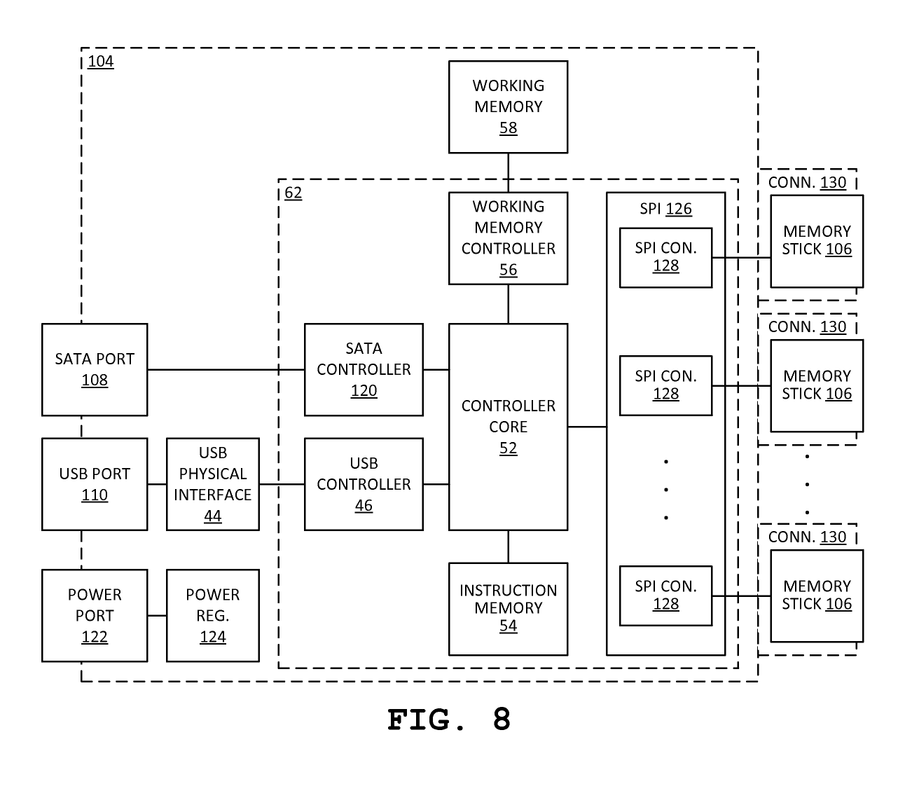

FIG. 8 shows a block diagram of a solid-state memory device, such as the solid-state memory devices 100 of FIG. 7. The components of the memory device shown in FIG. 8 are examples, and the functionality discussed below can be implemented in other kinds of components, fewer more generalized components, or a greater number of more specialized components. Like reference numerals identify like components, and redundant description is omitted for sake of clarity.

The solid-state memory device includes a controller core 52, instruction memory 54, a working memory controller 56, and working memory 58. The controller core 52 is connected to the instruction memory 54 and the working memory controller 56, which is connected to the working memory 58. The controller core 52, instruction memory 54, and working memory controller 56 may be implemented by a suitably configured FPGA 62 disposed on the controller board 104. The description of FIG. 3 may be referenced for further detail.

The solid-state memory device further includes a SATA controller 120 connecting the SATA port 108 and the controller core 52. In this embodiment, the SATA controller 120 is configured to provide 8-bit data transfer in response to read/write commands and handshaking and flow-control between the controller core 52 and a SATA bus located at a host device connected to the SATA port 108. The SATA controller 120 can comply with an industry standard. When implemented on the FPGA 62 such as the Spartan6, the SATA controller 120 can be connected to the data port 108 via high-speed gigabit transceiver pins, which can allow a glueless or direct interface to the SATA bus of the host device. The SATA controller 120 and SATA port 108 can be configured to allow the solid-state memory device to be connected to the host device just as a conventional hard disk drive.

The USB physical interface 44 and USB controller 46, which are discussed in detail elsewhere herein, provide with the USB port 110 a USB mass storage interface for the solid-state memory device. A user can thus select whether to connect the solid-state memory device to the host device (e.g. computer) via a SATA connection or a USB connection.

The solid-state memory device further includes a power port 122 and a connected power regulator 124. The power port 122 is configured to receive power, if required, from an external source and the power regulator 124 is configured to regulate supply power and provide operational power to the solid-state memory device at any required voltage.

The solid-state memory device further includes an SPI 126. The SPI 126 includes a plurality of SPI controllers 128. Each SPI controller 128 provides communication between the controller core 52 and one of the memory card sticks 106. Each SPI controller 128 is configured to translate read and write operations from the controller core 52 into standard SD card 4-bit command and data cycles. Further, each SPI controller 128 is configured to communicate in parallel with all of the memory cards 112 of the respective memory card stick 106. Each SPI controller 128 can also be connected to indicators (e.g., indicators 19 of FIG. 1) and control the indicators to illuminate depending on read/write access and/or fault conditions of the respective memory card stick 106.

A plurality of memory stick connectors 130 is connected to the SPI 126. Each memory stick connector 130 is configured to physically connect a memory card stick 106 to a respective SPI controller 128.

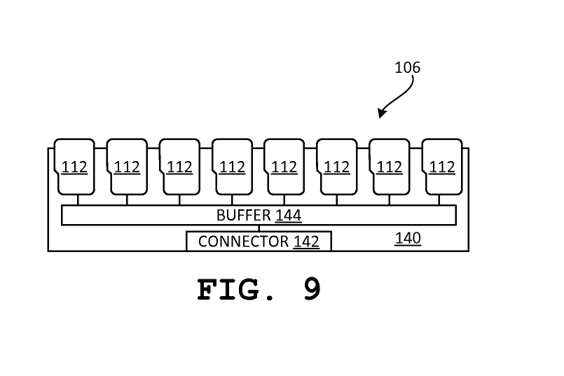

FIG. 9 shows a diagram of one of the memory card sticks 106. The memory card stick 106 includes a PCB 140 on which the memory cards 112 are mounted by way of removable or non-removable connections. The memory card stick 106 further includes a physical connector 142 and a buffer 144 that connects the connector 142 to each of the memory cards 112.

The connector 142 may be the same component as the respective connector 130 (FIG. 8), or may be configured to mate with the connector 130 in a removable or non-removable manner.

The buffer 144 can be configured to control signal integrity and reduce noise of data communications between the connector 142 and the memory cards 112.

In the example shown, eight microSD memory cards 112 are provided on each memory card stick 106. However, the number of memory cards 112 is not particularly limited. In some examples, a 50 Mhz data clock is used to access the memory cards 112 and each memory card 112 is accessed via a 4-bit interface port. This can provide read speeds of 200 MB/s and write speeds of approximately 150 MB/s. The memory cards 112 are capable of being accessed in parallel, such that two or four memory cards 112 can be in the same read or write queue. This can further increase read/write speeds to about 800 MB/s read and 600 MB/s write. Such a memory card arrangement, when accessed via the SATA port 108 (FIG. 8), can allow data transfer rates at SATA 1, SATA 2, or SATA 3 speeds.

With reference back to FIG. 8, the controller core 52 is configured to provide parallel read/write access to the memory cards 112 of each memory card stick 106. The controller core 52 is configured to provide parallel access to the memory card sticks 106. Hence, a total capacity of the solid-state memory device is about equal to the sum of capacities of memory cards 112. Further, the read/write access time to the total storage capacity is decreased, relative to a read/write access time for an individual memory card 112, because of the parallel access to the memory card sticks 106.

In this embodiment, the solid-state memory device processes all read, write, delete, and similar file-access operations substantially exactly as a standard SATA hard disk drive and/or USB memory stick. The solid-state memory device is capable of emulating a SATA hard disk drive.

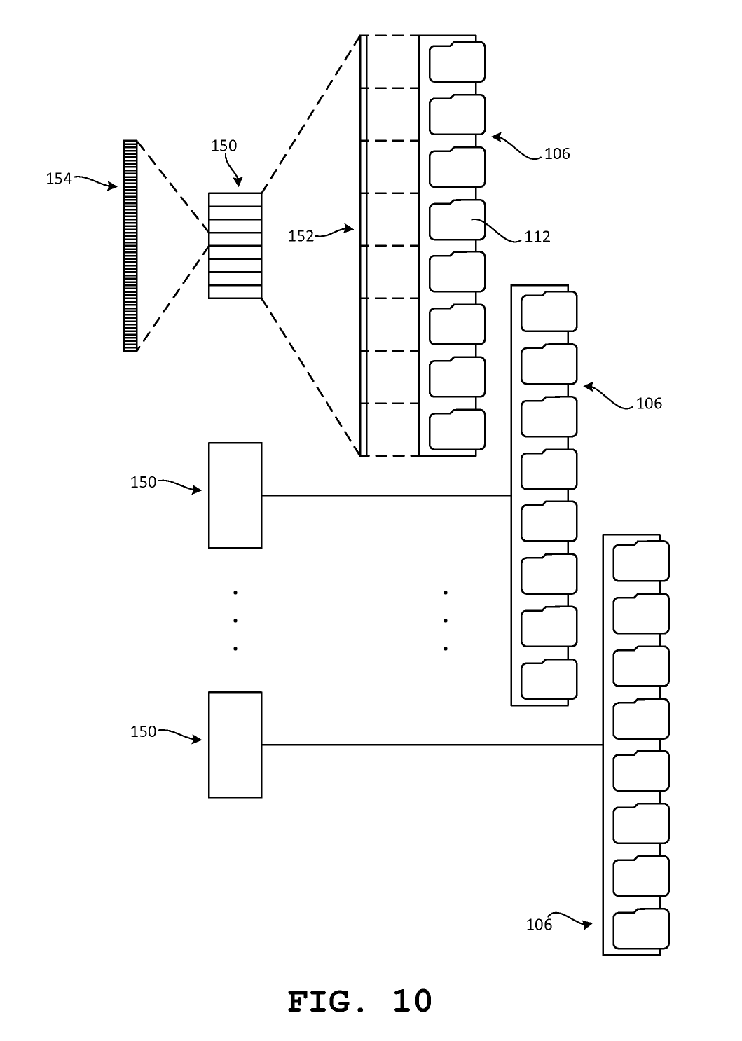

FIG. 10 illustrates a memory mapping that the controller core 52 uses to map memory requests from the host device to the individual memory cards 112 of the memory card sticks 106. The memory mapping can be stored in the instruction memory 54 (FIG. 8) of the solid-state memory device. The controller core 52 can be configured to reference the memory mapping to access the memory cards 112, as discussed elsewhere herein.

The memory mapping defines a memory sector 150 that has a width 152 of N bytes, where N is the number of memory cards 112 per memory card stick 106. In this example, eight memory cards 112 are used resulting in a sector width 152 of eight bytes or 64 bits. Further in this example, the total sector size is selected to be 4 kilobytes (KB). The memory sector 150 is mapped to a host sector 154 used at the host device. In this example, the host sector 154 is one byte wide and has a total size of 512 bytes, which is compatible with a standard sector used by common computer operating systems for access to hard disk drives and similar storage devices.

Thus, in this example, the memory mapping maps a standard 8-bit-wide 512 byte host sector 154 to a 64-bit-wide 4 KB memory-card sector 150.

In this embodiment, the memory cards 122 of each memory card stick 106 are accessed in parallel, without the capability of individual memory card access, resulting in the memory card stick 106 operating as a virtualized 64-bit wide memory card.

In this example, eight host sector 154 (512 bytes each) are mapped to one memory sector 150 (4 KB). Hence, a linear group of 64 host sectors 154 (32 KB) maps to eight memory sectors 150, while a linear group of 128 host sectors 154 (32 KB) maps to 16 memory sectors 150.

The memory mapping can further sequentially map memory sectors 150 to the memory card sticks 106. That is, for a group of memory sectors 150, the next memory sector 150 is assigned to the next memory card stick 106. For example, when 25 memory card sticks 106 are used, a first memory sector 150 is mapped to a first memory card stick 106, a second memory sector 150 is mapped to a second memory card stick 106, and so on, with a twenty-sixth memory sector 150 being mapped to a second memory sector of the first memory card stick 106.

Hence, the memory mapping can allow for writing and reading multiple memory sectors 150 in parallel because each memory sector 150 is sequentially mapped to a different memory card stick 106. Such parallel writing can result in increased speed for memory accesses up to the number of memory card sticks 106 used. In the example of 25 memory card sticks 106, approximately 100 KB (25 memory sectors of 4 KB) can be written simultaneously. Memory sector 150 to be written that number above the number memory card sticks 106 can be queued.

The solid-state device discussed above provides for access to multiple memory cards simultaneously to emulate a high-density, high-speed hard drive. Sector order is configured so that a sequential arrangement of sectors of a hard disk is mapped to the memory card sticks 106, allowing parallel/queued access for sequential sector reads and writes. The sector mapping is parallelized over individual memory cards, increasing access speeds. The solid-state device can read or write many sectors at once, keeping the USB or SATA interfaces full of data, in response to the host device requesting 32, 64, 128, or more sectors at a time.

In other embodiments, the controller core 52 is configured to operate the plurality of memory card sticks 106 as a RAID. RAID mirroring can be implemented to allow for data redundancy to help prevent data loss. Any RAID level (e.g., RAID 1, RAID 2, etc.) practical can be used. In other embodiments, the controller core 52 is configured to provide data encryption to provide a highly secure and fault tolerant mass storage device.

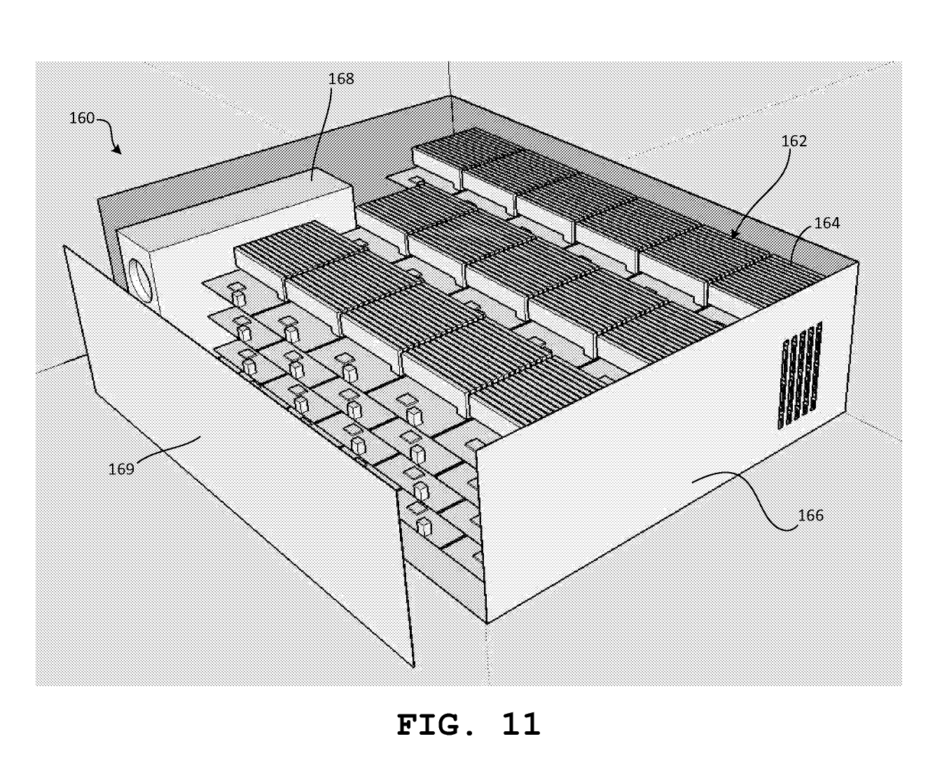

With reference to FIG. 11, the present invention includes one or more solid-state memory devices 162 configured as a rack unit 160. The solid-state memory device 162 can be any of the solid-state memory devices described herein. The solid-state memory device 162 can include a plurality of memory card sticks 164, which may include a plurality of memory cards (e.g., SD, miniSD, microSD, as discussed above), as described elsewhere herein. Additionally or alternatively, a solid-state memory device 162 in the rack unit 160 can include a solid-state drive (SSD) that does not use removable memory cards and memory sticks. In this embodiment, a plurality of similar or identical solid-state memory devices 162 are configured as the rack unit 160.

The rack unit 160 includes a housing 166 that contains the solid-state memory devices 162, a power supply 168 that is connected to the solid-state memory devices 162 to provide power thereto, and a removable cover 169. The housing 166 includes ventilation openings and internal supports to for holding the solid-state memory devices 162. The power supply 168 is configured to adjust and condition mains power for use by the solid-state memory device 162 and may include an uninterruptable power source (UPS). The removable cover 169 is removably attached to the front of the rack unit 160 to permit access to the solid-state memory devices 162 to allow swapping out of an entire solid-state memory device 162, a memory card stick on the device 162, or an individual memory card on a stick. Each solid-state memory device 162 may be individually removable and hot-swappable from the rack unit 160, so that is can be replaced with another solid-state memory device 162. Each memory card stick and each memory card of each solid-state memory device 162 may be individually removable and hot-swappable as discussed elsewhere herein. The power supply 168 is smaller than conventional rack units that use hard drives with similar total storage capacity due to the reduced power demand of the solid-state memory devices described herein.

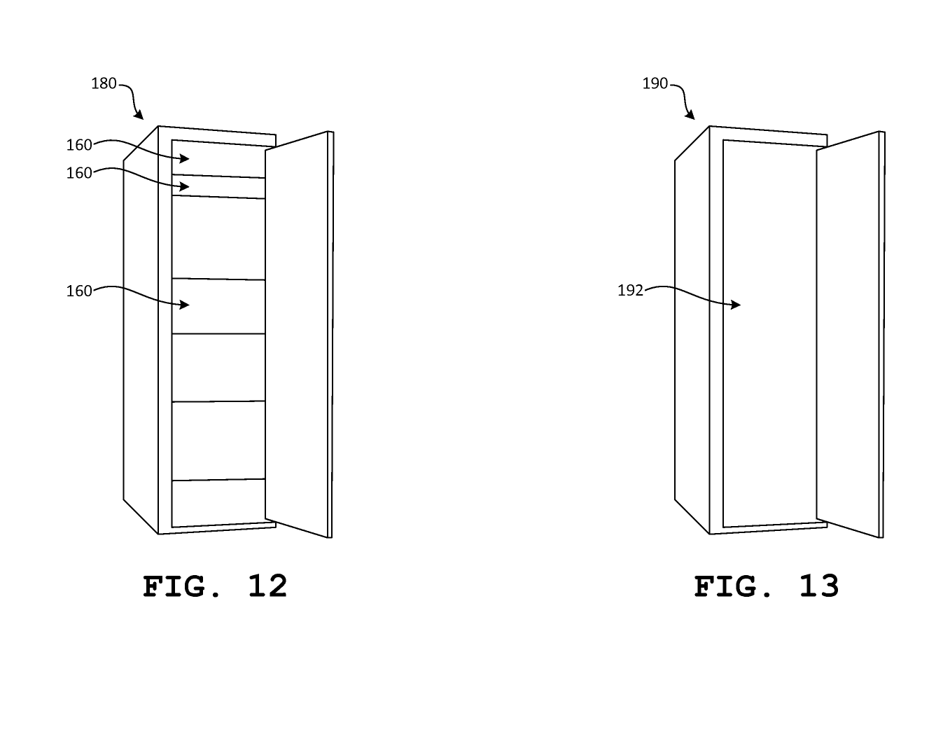

The rack unit 160 can be a 4U unit as depicted or any other size, such as 1U, 2U, etc., with the housing 166 shaped and sized accordingly. The rack unit 160 can be installed into a standard data-center rack or cabinet 180, as shown in FIG. 12. The data-center rack 180 can be of a standard 42U size and can hold any appropriate number and size of rack units 160 totaling 42U or less. Other components such as servers, uninterruptable power sources, interfaces, and similar devices can be installed in the same rack 180 as one or more rack units 160.

As shown in FIG. 13, a customized data-center rack or cabinet 190 can include any number of solid-state memory devices, shown at 192, directly installed into the rack 190. This removes the constraint of following the 1U, 2U, etc. standard and can allow for a more efficient or cost effective configuration of solid-state memory devices. Any of the solid-state memory devices described herein can be used in the rack or cabinet 190.

Other high-capacity form factors are also contemplated, such as desktop boxes, tower servers, and similar.

High storage densities can be achieved with the embodiments shown in FIG. 11-13, while maintaining the other advantages of the solid-state memory devices described herein.

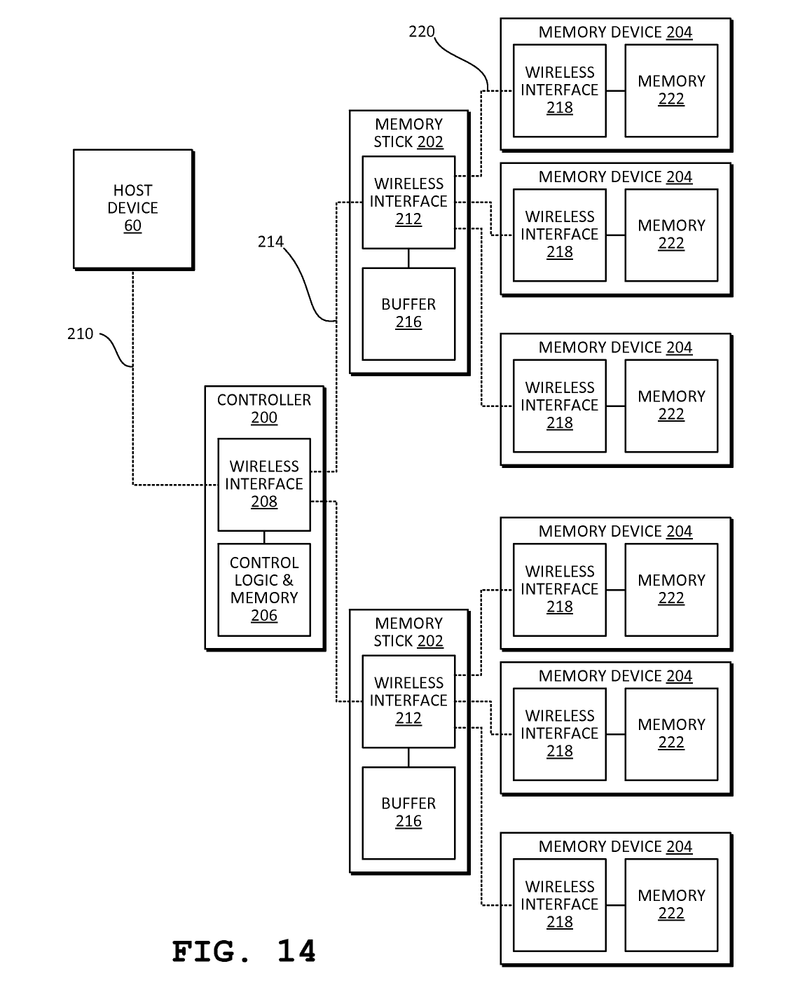

FIG. 14 shows another solid-state memory device according the present invention. The components of the memory device shown in FIG. 14 are examples, and the functionality discussed below can be implemented in other kinds of components, fewer more generalized components, or a greater number of more specialized components. Like reference numerals identify like components, and redundant description is omitted for sake of clarity.

The solid-state memory device includes a controller 200, a plurality of memory sticks 202, and a plurality of memory devices 204. The controller 200, memory sticks 202, and memory devices 204 are similar to the components discussed elsewhere herein. For instance, the controller 200 includes one or more of the components shown as installed at the controller board 104 of FIG. 8, and particularly the controller core 52, the instruction memory 54, and the working memory controller 56 and working memory 58. The memory sticks 202 can include components and functionality of the memory card sticks 106, and the memory devices 204 can include memory cards (e.g., SD, miniSD, microSD, etc.). The controller 200, memory sticks 202, and memory devices 204 also operate in parallel and according to the memory mapping, as discussed above with respect to FIG. 10, with the memory sticks 202 and memory devices 204 being removable and hot-swappable from the solid-state memory device. The fault tolerance, RAID, and encryption features discussed above may also be implemented with the solid-state memory device. The controller 200, memory sticks 202, and memory devices 204 are mutually connected via wireless communications and connected to a host device 60 via wireless communications.

The controller 200 includes control logic and memory 206, such as the controller core 52, the instruction memory 54, and the working memory controller 56 and working memory 58 described with reference to FIG. 8. The control logic and memory 206 may further include other components described with respect to FIG. 3 and FIG. 8. The control logic and memory 206 is configured to control memory access according to the parallelized memory mapping described with respect to FIG. 10. Further, control logic and memory 206 may be configured for fault tolerance, RAID, and encryption, as discussed elsewhere herein.

The controller 200 further includes a short- or medium-range wireless interface 208, such as a Bluetooth, Wi-Fi, WiMAX, or similar interface. The wireless interface 208 includes a wireless transmitter, wireless receiver, wireless transceiver, or combination of such with one or more suitable antennas. The wireless interface 208 is configured to provide a host wireless link 210 to communicate instructions and data between the controller 200 and a host device 60, such as a desktop/laptop computer, smartphone, server, or other digital device that includes a compatible wireless interface. The wireless interface 208 is further configured to communicate instructions and data between the controller 200 and the memory sticks 202. Alternatively, one or more additional wireless interfaces can be provided to the controller 200 for communication with the memory sticks 202. Such additional wireless interfaces can be of the same or different scheme (Bluetooth, Wi-Fi, WiMAX, etc.) as the wireless interface 208.

Each memory stick 202 includes a short- or medium-range wireless interface 212, such as a Bluetooth, Wi-Fi, WiMAX, or similar interface. The wireless interface 212 includes a wireless transmitter, wireless receiver, wireless transceiver, or combination of such with one or more suitable antennas. The wireless interface 212 is configured to provide a controller wireless link 214 with the controller 200 to communicate instructions and data between the controller 200 and the memory stick 202. The wireless interface 212 is further configured to communicate instructions and data with a subset of the memory devices 204. Alternatively, one or more additional wireless interfaces can be provided to the memory stick 202 for communication with the memory devices 204. Such additional wireless interfaces can be of the same or different scheme (Bluetooth, Wi-Fi, WiMAX, etc.) as the wireless interface 212.

Each memory stick 202 can further include a buffer 216 for buffering data and instructions during transit between the memory stick 202 and the linked memory devices 204. The buffer 216 can be configured to control signal integrity and reduce noise of data communications between the memory stick 202 and the linked memory devices 204.

Each memory device 204 includes a short- or medium-range wireless interface 218, such as a Bluetooth, Wi-Fi, WiMAX, or similar interface. The wireless interface 218 includes a wireless transmitter, wireless receiver, wireless transceiver, or combination of such with one or more suitable antennas. The wireless interface 218 is configured to provide a memory wireless link 220 with one of the memory sticks 202 to communicate instructions and data between the memory device 204 and the memory stick 202. Each memory device 204 further includes memory 222, such as a memory card (e.g., SD, miniSD, microSD, etc.), an SSD, or similar. It is noted that the techniques discussed elsewhere herein describing how memory cards are connected, mapped, and controlled apply equally to SSDs.

Each of the controller 200, memory sticks 202, and memory devices 204 can store unique identifiers (such as media access control, MAC, addresses) so that they can be identified for purposes of wireless communications. That is, the controller 200 has an identifier that is referenced by the host device 60 and the memory sticks 202 to identify the controller 200 and differentiate the controller 200 from other devices, such as the memory devices 204, using the same wireless communications scheme and within range. Similarly, each memory stick 202 has an identifier that is referenced by the controller 200 and the memory devices 204 to identify the memory stick 202 and differentiate the memory stick 202 from other devices using the same wireless communications scheme and within range. Likewise, each memory device 204 has an identifier that is referenced by the memory sticks 202 to identify the memory device 204 and differentiate the memory device 204 from other devices using the same wireless communications scheme and within range. Each of the controller 200, memory sticks 202, and memory devices 204 can be configured to associate with a respective controller 200, memory stick 202, and memory device 204 referencing the unique identifiers. The controller 200 associates with the plurality of memory sticks 202 and each memory stick 202 associates with a different subset of the plurality of memory devices 204. Associations among devices may be established as part of pairing or other process of the wireless communications scheme. Associations with memory sticks 202 and among memory sticks 202 and memory devices 204 may be stored in the control logic and memory 206 of the controller 200. When a memory stick 202 cannot be accessed by the controller 200, the controller 200 marks the associated memory devices 204 as removed from the solid-state memory device. If wireless connectivity to the memory stick 202 is re-established, the controller 200 marks the associated memory devices 204 as available. When wireless connectivity to a new memory stick 202 is established, the controller 200 enumerates the memory devices 204 associated with the memory stick 202. The controller 200 may, for example when RAID is implemented, copy data from existing memory devices 204 to the memory devices 204 of the new memory stick 202. The same concepts above apply to the individual memory devices 204 when wireless connections with respective memory sticks 202 are established, lost, and re-established.

In this embodiment, it is preferable that each memory device 204 is associated with only one memory stick 202 at a given time and that each memory stick 202 is associated with only one controller 200 at a given time. The controller 200 can be configured to manage wireless connections accordingly.

It is noted that the memory sticks 202 and memory devices 204 are not computers or similar processing devices. That is, the functionality of the memory sticks 202 and memory devices 204 is limited to storage and retrieval of data and related processes. This advantageously reduces complexity and potentially increases data access speeds.

The memory mapping described above for other embodiments applies equally to the present embodiment. The memory mapping references the unique identifiers of the memory sticks 202 and memory devices 204 to distribute data among the memory devices 204 and to retrieve data from the memory devices 204. The host device 60 need only be aware of the identifier of the controller 200.

In some embodiments, the controller 200, the memory sticks 202, and memory devices 204 are configured to form an ad-hoc or private wireless network as a virtual storage pool, in which each memory stick 202 and each memory device 204 has a private wireless MAC address that is associated with segments/sectors of the virtual storage pool. As above, the controller 200 is the main wireless interface with the host 60. Further, the controller 200 is configured to maintain a mapping of private wireless MAC addresses to segments/sectors of the virtual storage pool to translate host requests to the relevant sticks 202 and devices 204. The controller 200 is configured to intercept format commands from the host 60 when first creating a file system for the virtual storage pool and is further configured to reference the format commands to construct the mapping. That is, the controller 200 can be configured to construct a table to record which sticks 202 and devices 204 form which specific parts of the virtual storage pool, as well as update the table if or when sticks 202 and devices 204 are added, removed, or replaced. In one example, such a table includes private wireless MAC addresses of the sticks 202 and devices 204 in association with segments/sectors of the virtual storage pool as visible to the host 60. The controller 200 can be configured to maintain a table of pointers and to provide a user interface to the host 60, such that the table of pointers can be accessed by the host 60 to output statistics, such as usage levels, and to allow replacement of specific memory sticks 202 and memory devices 204 within the virtual storage pool. In these embodiments, banks of wireless memory sticks 202 and wireless memory devices 204 pool together and can be automatically detected as one large disk with the ability to readily add/remove/replace memory sticks 202 and memory devices 204.

In operation, the host device 60 and the controller 200 establish a wireless connection via the host wireless link 210, the controller 200 establishes wireless connections with memory sticks 202 via controller wireless links 214, and each memory stick 202 establishes wireless connections with respective subsets of memory devices 204 via memory wireless links 220. Commands from the host device 60 to store and retrieve data are sent to the controller 200, which interprets the commands and sends corresponding instructions to the relevant memory sticks 202, which in turn instruct the relevant memory devices 204. Data is stored in or retrieved from the memory devices 204 in response to the instructions.

The embodiment of FIG. 14 can advantageously be used with the rack and cabinet embodiments of FIGS. 11-13. For instance, a 1U controller rack unit can manage a 1U memory stick rack unit that manages eight 4U memory device rack units, with wireless communications transmitting commands and data there-between as well between the control rack unit and a host device, which may be installed in the same rack. In another example, an 8U rack unit includes a controller 200, associated memory sticks 202, and associated memory devices 204 in a self-contained arrangement that communicates internally via wireless communications and that communicates externally with a host device via wireless communications. Other examples are also contemplated.

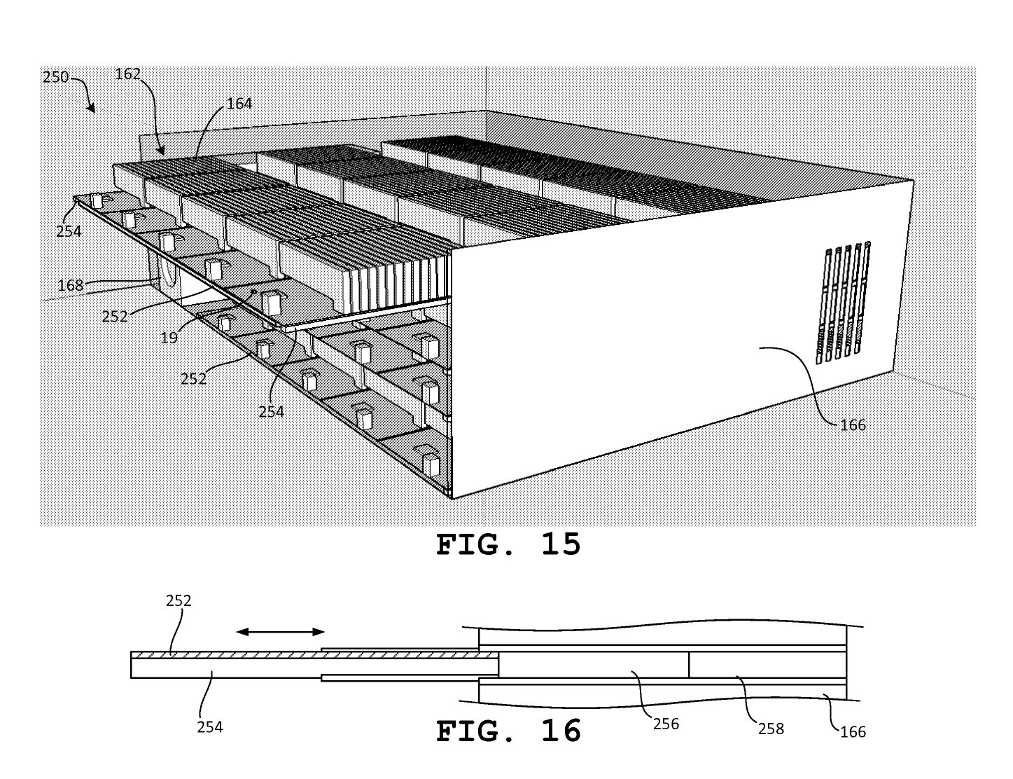

With reference to FIG. 15, the present invention includes one or more solid-state memory devices 162 configured as a rack unit 250. The rack unit 250 is similar to the rack unit 160 and only differences will be discussed in detail. Like reference numerals denote like components, and the description above for the rack unit 160 can be referenced. The rack unit 250 houses a plurality of solid-state memory devices 162, such as any of the solid-state memory devices described herein. In the example shown, the rack unit 250 is a 4U unit.

The rack unit 250 includes a plurality of trays 252 vertically staked within the rack unit 250. A plurality of solid-state memory devices 162 are removably attached to an upper surface of each tray 252. Each tray 252 thereby mechanically supports an attached plurality of solid-state memory devices 162. A tray 252 may also include electrical connections, such as connector ports, for providing power and/or data connections to the supported solid-state memory devices 162. In such case, at least one flexible cable connects the electrical connections on the tray 252 to a main bus or other system of the rack unit 250. Alternatively, the tray 252 does not include electrical connections and power and/or data connections to the solid-state memory devices 162 are made via flexible cables to a main bus or other system of the rack unit 250. In still another example, the tray 252 includes electrical connections to provide power to the supported solid-state memory devices 162, while data connections with the devices 162 are made via flexible cable or are wireless. Generally, each of a power connection and a data connection for a device 162 may be provided via (a) rigid connector at the supporting tray 252 and a flexible cable from the supporting tray 252 to a main bus or other system of the rack unit 250 or (b) a flexible cable from the device 162 to a main bus or other system of the rack unit 250. Further, a data connection for a device 162 may be provided wirelessly without a cable or rigid connector.

Each tray 252 is supported within the rack 250 by at least one slidable rail 254. Each slidable rail 254 is coupled to the housing 166 of the rack unit 250 and is configured to slide the tray 252 with the supported solid-state memory devices 162 attached out of the housing 166, when the cover 169 (not shown) is removed, for visual inspection and swapping of a solid-state memory device 162 or an individual memory card stick or memory stick. As mentioned elsewhere herein, indicators 19, such as LEDs, can be provided to the solid-state memory devices 162 to visually indicate faults, among other things, to facilitate inspection. Such indicators 19 may be configured to indicate faults with an individual memory card, a memory card stick, and/or a solid-state memory device 162. Advantageously, the tray 252 and rail 254 system allows for easy access to the solid-state memory devices 162 to hot-swapping of devices, sticks, and cards, as well as for quick and convenient inspection.

FIG. 16 shows a side-view of a rail arrangement configured to slide the tray 252 in and out of the rack 250. A slidable rail 254, to which the tray 252 is affixed, may be nested telescopically with an intermediate slidable rail 256 that is nested telescopically with a stationary base rail 258 that is affixed to the inside of the housing 166 of the rack 250. Any number of intermediate slidable rails 256 may be used. The intermediate slidable rail 256 may be omitted, so that the slidable rail 254 is coupled directly to the stationary base rail 258. The telescopically sliding mechanical connections between the rails may include bearings, bushings, and similar.

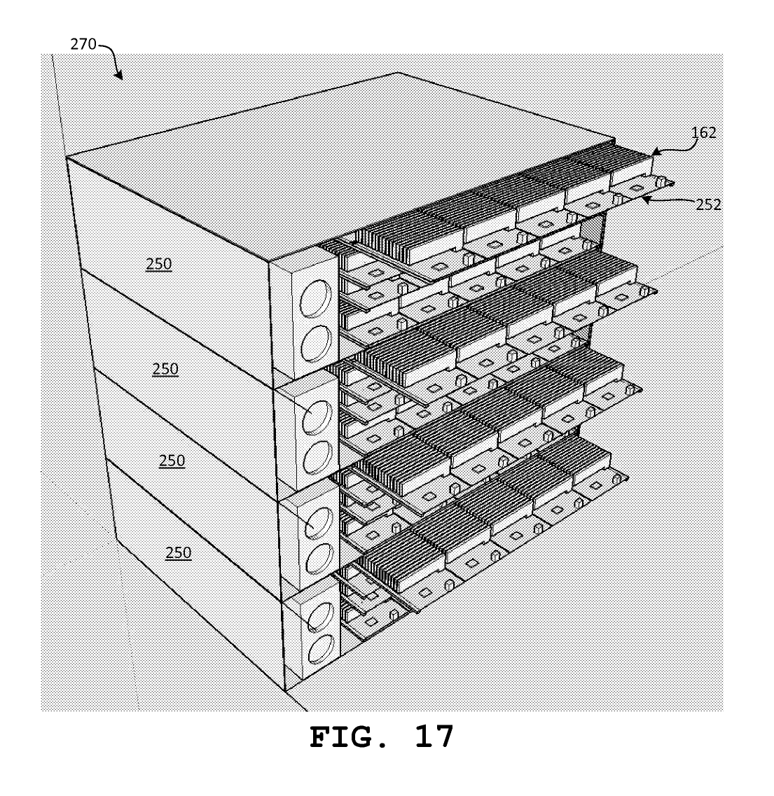

FIG. 17 shows an assembly 270 of a plurality of rack units 250 into a cabinet or other vertically stacked arrangement. Each tray 252 of each rack unit can be individually slid out for inspection and hot swapping of solid-state memory devices 162, memory card sticks, or individual memory cards. Advantageously, each element of a very large array of storage elements, down to a single individual memory card, can be individually inspected and hot swapped in case of fault or other need.

Although the techniques above are described with respect to SD cards, this is not intended to be limiting, and various aspects of the invention can be applied with other memory technologies that are currently available, that are under development, or that have not yet been developed. Various aspects of the invention are applicable to any type of memory, and the type of memory used can be abstracted and need not be known by the system. Examples of memory technologies that can be used with various aspects of the invention include SD cards, Flash memory, dynamic random-access memory (DRAM), magnetic storage such as hard disk drives, memristor devices, phase-change memory (PCM), and spin-transfer torque random-access memory (STT-RAM). Each of these memory technologies can be applied as memory devices, memory sticks, or memory cards, as discussed elsewhere herein.

Advantages of the present invention can include a lack of moving parts, reduced heat generation, reduced noise generation, and low-cost capacity that may effectively replace hard disk drives and/or USB mass storage devices. Further, the present invention can provide for cheaper and denser storage capacity than some kinds of solid-state drives (SSDs). In addition, the capacity of a plurality of memory cards is combined in an efficient, user-friendly, and data-safe manner. In terms of high capacity, when 25 memory card sticks each containing eight 128 GB microSD cards are used, the resulting solid-state drive's capacity is about 25 TB. In addition, high-capacity form factors and wireless connectivity can provide for high-density applications with fewer constraints on physical placement.

While the foregoing provides certain non-limiting example embodiments, it should be understood that combinations, subsets, and variations of the foregoing are contemplated. The monopoly sought is defined by the claims.

What is claimed is:

1. A solid-state memory device comprising:
a rack unit housing shaped and sized to fit a data-center rack or cabinet;
a plurality of memory devices disposed within the rack unit housing;
a plurality of memory sticks disposed within the rack unit housing, each memory stick of the plurality of memory sticks coupled to a subset of memory devices of the plurality of memory devices;
a controller configured for parallel access to the plurality of memory devices through the plurality of memory sticks to access the plurality of memory devices as a virtualized memory device and to present to a host a single non-volatile storage unit with a total capacity based on capacities of the plurality of memory devices;
the controller further configured to operate according to a memory mapping to map memory requests from the host to the plurality of memory devices, the memory mapping defining a memory sector for access to each memory stick of the plurality of memory sticks, the memory sector mapping to a plurality of host sectors defined by the host, each host sector of the plurality of host sectors mapped to a different memory device of each memory stick; and
each memory sector of a plurality of memory sectors being mapped to a different memory stick for writing and reading the plurality of memory sectors in parallel to increase speed of memory accesses.

2. The device of claim 1, wherein the controller comprises a wireless interface and at least one memory stick of the plurality of memory sticks comprises a wireless interface, the wireless interface of the controller and the wireless interface of the at least one memory stick configured to wirelessly communicate instructions and data between the controller and the at least one memory stick.

3. The device of claim 2, wherein at least one memory stick of the plurality of memory sticks comprises a wireless interface and at least one memory device of the plurality of memory devices comprises a wireless interface, the wireless interface of the at least one memory stick and the wireless interface of the at least one memory device configured to wirelessly communicate instructions and data between the at least one memory stick and the at least one memory device.

4. The device of claim 1, further comprising a power supply disposed within the rack unit housing for providing power to the solid-state memory device.

5. The device of claim 1, wherein each memory device of the plurality of memory devices comprises a solid-state drive.

6. The device of claim 1, wherein each memory stick of the plurality of memory sticks is a memory card stick and each memory device of the plurality of memory devices comprises a memory card.

7. The device of claim 1, wherein each memory device of the subset of memory devices is hot-swappable from each memory stick.

8. The device of claim 1, further comprising a slidable tray supporting the plurality of memory devices and the plurality of memory sticks within the rack unit housing, the slidable tray configured to slide into the rack unit housing and out of the rack unit housing for inspection and hot swapping of at least one of the plurality of memory devices and the plurality of memory sticks.

9. A data-center rack or cabinet comprising a plurality of the solid-state memory devices of claim 1.

10. A solid-state memory device comprising:
a plurality of memory devices;
a plurality of memory sticks, each memory stick of the plurality of memory sticks coupled to a subset of memory devices of the plurality of memory devices;
a controller configured for parallel access to the plurality of memory devices through the plurality of memory sticks to access the plurality of memory devices as a virtualized memory device and to present to a host a single non-volatile storage unit with a total capacity based on capacities of the plurality of memory devices;
the controller including a wireless interface and at least one memory stick of the plurality of memory sticks including a wireless interface, the wireless interface of the controller and the wireless interface of the at least one memory stick configured to wirelessly communicate instructions and data between the controller and the at least one memory stick; and
at least one memory device of the plurality of memory devices including a wireless interface, the wireless interface of the at least one memory stick and the wireless interface of the at least one memory device configured to wirelessly communicate instructions and data between the at least one memory stick and the at least one memory device.

11. The device of claim 10, wherein the controller is further configured to operate according to a memory mapping to map memory requests from the host to the plurality of memory devices, the memory mapping defining a memory sector for access to each memory stick of the plurality of memory sticks, the memory sector mapping to a plurality of host sectors defined by the host, each host sector of the plurality of host sectors mapped to a different memory device associated with each memory stick, and each memory sector of a plurality of memory sectors being mapped to a different memory stick for writing and reading the plurality of memory sectors in parallel to increase speed of memory accesses.

12. The device of claim 10, wherein each of the memory sticks of the plurality of memory sticks includes a wireless interface, such that all memory sticks are configured to wirelessly communicate instructions and data with the controller.

13. The device of claim 10, wherein each of the memory devices of the plurality of memory devices includes a wireless interface, such that all memory devices are configured to wirelessly communicate instructions and data with the plurality of memory sticks.

14. The device of claim 10, wherein each memory device of the plurality of memory devices comprises a solid-state drive.

15. The device of claim 10, wherein each memory stick of the plurality of memory sticks is a memory card stick and each memory device of the plurality of memory devices comprises a memory card.

16. The device of claim 10, wherein each memory device of the subset of memory devices is hot-swappable from each memory stick.

17. The device of claim 10, further comprising a rack unit housing shaped and sized to fit a data-center rack or cabinet, wherein the plurality of memory devices, plurality of memory sticks, and the controller are disposed within the rack unit housing.

18. The device of claim 17, further comprising a slidable tray supporting the plurality of memory devices and the plurality of memory sticks within the rack unit housing, the slidable tray configured to slide into the rack unit housing and out of the rack unit housing for inspection and hot swapping of at least one of the plurality of memory devices and the plurality of memory sticks.
